(19) United States
(12) Patent Application Publication
(10) Pub. No.: US 2020/0270277 A1
(43) Pub. Date: Aug. 27, 2020

(54) POROUS MATERIALS HAVING A SULFUR NANOSTRUCTURED YOLK AND A CARBONIZED METAL ORGANIC FRAMEWORK SHELL AND USES THEREOF

(71) Applicant: SABIC Global Technologies B.V., Bergen op Zoom (NL)

(72) Inventors: Yunyang LIU, Thuwal (SA); Ihab N. ODEH, Thuwal (SA)

(21) Appl. No.: 16/620,995

(22) PCT Filed: Jun. 14, 2018
(86) PCT No.: PCT/US2018/037434

§ 371 Date: Dec. 10, 2019

Related U.S. Application Data
(60) Provisional application No. 62/520,690, filed on Jun. 16, 2017.

(51) Int. Cl. C07F 3/06; H01M 4/36; H01M 4/1397; H01M 10/052; C01B 17/22

(52) U.S. Cl. CPC C07F 3/06; H01M 4/366; B82Y 30/00; H01M 10/052; C01B 17/22; H01M 4/1397

(57) ABSTRACT

Porous carbon materials having a yolk-shell structure, methods of making and uses thereof are described. The porous carbon materials can have a sulfur-based yolk positioned within a hollow space of by a porous carbonized metal organic framework (MOF) shell.

### CROSS REFERENCE TO RELATED APPLICATIONS

The application claims priority to U.S. Provisional Application No. 62/520,690, filed Jun. 16, 2017, which is incorporated by reference in its entirety without disclaimer.

### BACKGROUND OF THE INVENTION

### A. Field of the Invention

The invention generally concerns porous materials having yolk-shell type structures that can be used in energy storage devices. In particular, the porous material includes a sulfur-based nanostructured yolk positioned within a hollow space of a porous carbonized metal organic framework (MOF) shell.

### B. Description of Related Art

Energy demand across the globe has been steadily increasing. This can have a negative impact on the environment unless more environmentally friendly energy storage options are developed that are safe, inexpensive, and/or have high energy storage densities. Among the most promising energy storage devices are lithium-sulfur (Li—S) batteries. These batteries have attracted much attention in recent years due to their high theoretical capacity of 1672 mAh g⁻¹, which is over 5 times that of currently used transition metal oxide cathode materials. Further, Li—S batteries can be made at relatively low cost due, in part, to abundant natural sulfur resources. Further, these batteries are relatively nonpoisonous and environmentally benign when compared with other energy storage devices. However, the practical application of Li—S cells is still limited by at least the following drawbacks: 1) poor electrical conductivity of sulfur (5×10⁻³° S cm⁻¹), which limits the utilization efficiency of the active material and rate capability; 2) high solubility of polysulfide intermediates in the electrolyte results in shuttling effect in the charge-discharge process; and 3) large volumetric expansion (˜80%) during charge and discharge, which results in rapid capacity decay and low coulombic efficiency.

During the charge and discharge cycle of a Li—S cell, electrochemical cleavage and re-formation of sulfur-sulfur bonds can occur. In particular, the reduction of sulfur to lithium higher polysulfides (Li₂Sₙ where 4≤n≤8) is followed by further reduction to lithium lower polysulfides (Li₂Sₙ where 1≤n≤3). The higher polysulfides can be dissolved into the organic liquid electrolyte, enabling them to penetrate through a polymer separator between the anode and cathode, and then react with the lithium metal anode, leading to the loss of sulfur active materials. Even if some of the dissolved polysulfides diffuse back to the cathode during the recharge process, the sulfur particles formed on the surface of the cathode are electrochemically inactive owing to the poor conductivity. Such a degradation path leads to poor capacity retention, especially during long cycling (e.g., more than 100 cycles).

Various attempts to improve Li—S battery cells while inhibiting polysulfide dissolution and shuttling have been described. By way of example, Chinese Patent Application Publication No. 105384161 to Zhang et al. describes a sulfur-laden hierarchical porous carbon material prepared by mixing elemental sulfur with a hierarchical porous carbon material made from a carbonized zinc oxide ZIF. In another example, U.S. Pat. No. 9,437,871 to Zhou et al. describes a polymer coated carbon shell having a sulfur core. In yet another example, Chinese Patent Application Publication No. 10533379 to Zhang et al. and Jayaprakash et al. (Angew. Chem. Int. Ed., 2011, 50, 5904) each describe core-shell structures that have a sulfur core and a calcined and carbon shell made from phenolic resins or petroleum pitch.

Despite all of the currently available research on Li—S based energy storage devices, many of these devices continue to suffer from capacity degradation during charge-discharge cycles. These devices can also suffer from complex and non-environmentally friendly manufacturing protocols, low active material loading, and/or decreased electronic conductivity, any of which can contribute to overall unsatisfactory electrochemical performances.

### SUMMARY OF THE INVENTION

A solution to some of the problems associated with expansion and de-expansion of carbon-based materials and the shuttling effect seen with polysulfides has been discovered. The solution lies in the ability to design a yolk-shell material that allows for the absorption of metal ions (e.g., lithium ions) while reducing or inhibiting polysulfide dissolution. In particular, a sulfur-based material is positioned within a hollow space of a carbonized metal organic framework (MOF) shell. The nanostructured elemental sulfur yolk can absorb metal ions (e.g., Li ions) and expand in the void space of the porous carbonized shell (e.g., a volume expansion of at least 50%) without deforming/expanding the shell. In preferred aspects, the porous carbonized MOF shell can include nitrogen. Nitrogen doping can increase absorptivity of sulfur compounds, thus reducing polysulfide dissolution. The methods of the current invention also provide an elegant process for incorporation of nitrogen into the porous carbonized MOF shell. By way of example, a MOF precursor that includes nitrogen atoms can be used to in-situ grow a nitrogen doped ((N-doped) organic framework shell on a metal oxide (e.g., ZnO) surface to form nitrogen doped MOF core-shell structures. After carbonization and removal of the metal oxide, hollow carbon spheres can be formed. Sulfur-based materials (e.g., elemental sulfur or lithium sulfide) can then be incorporated (e.g., impregnated) into the hollow carbon sphere to form a sulfur/nitrogen doped carbonized yolk/shell structure. Such a method can result in a substantially or completely defect-free porous nitrogen doped carbonized shell encapsulating sulfur-based yolks. The resulting material can be used in energy storage devices.

In one aspect of the invention, porous materials having yolk-shell type structures are described. A porous material can include a sulfur-based material positioned within a hollow space of a porous carbonized metal organic framework (MOF) shell. The carbonized shell can be defect free (e.g., the shell is a continuous surface). In some embodiments, the shell is nitrogen doped. The N-doped shell can include 2 to 40 wt. %, 25 wt. % to 35 wt. %, or 27 wt. % to 32 wt. % of elemental nitrogen with the balance being elemental carbon. In some embodiments, the MOF can be a zeolitic imidazolate framework (ZIF) (e.g., ZIF-1 to a ZIF-100, a hybrid ZIF, a ZIF7-8, a ZIF8-90, a ZIF7-90, a functionalized ZIF, a ZIF-8-90, a ZIF7-90, preferably the ZIF is ZIF-8). The sulfur-based material can be elemental sulfur or lithium sulfide.

Methods of producing the porous material having a yolk-shell structure are described. A method can include at least four steps, steps (a)-(d). In step (a), an organic framework (OF) precursor can be combined with a suspension that can include at least one metal oxide (e.g., zinc oxide (ZnO), magnesium oxide (MgO), iron oxide (FeO and/or Fe2O3), strontium oxide (SrO), nickel oxide (NiO), cobalt oxide (CoO and/or Co2O3), calcium oxide (CaO), cadmium oxide (CdO), copper oxide (CuO), or mixtures thereof) under conditions suitable to produce a metal organic framework (MOF) material having a core-shell structure with a metal oxide core and an organic framework shell. The organic framework shell can include carbon and nitrogen atoms. The metal oxide suspension can include a metal oxide (e.g., zinc oxide (ZnO)), alcohol, and water. The organic framework precursor can be a bidentate carboxylate, a tridentate carboxylate, an amino substituted aromatic dicarboxylic acid, an amino substituted aromatic tricarboxylic acid, an azido substituted aromatic dicarboxylic acid, an azido substituted aromatic tricarboxylic acid, a triazole, a substituted triazole, an imidazole, a substituted imidazole, or mixtures thereof, preferably 2-methylimidazole. Conditions in step (a) can include agitating the suspension for a time sufficient to allow the organic framework to self-assemble around the metal oxide (e.g., agitation for 15 to 60 min at 0° C. to 100° C.) to form a nitrogen doped MOF. In step (b) of the method, the nitrogen doped MOF material can be heat-treated under conditions sufficient to carbonize the organic framework shell to produce a core-shell material that includes a metal oxide (e.g., ZnO) core and a porous carbonized shell. Heat-treating can include heating the nitrogen doped MOF core-shell material to a temperature of 550° C. to 1100° C. under an inert atmosphere to carbonize the organic framework and form the porous carbonized shell that encompasses the metal oxide core (e.g., ZnO core). Step (c) of the method can include subjecting the metal oxide core-porous carbonized shell material of step (b) to conditions sufficient to remove the metal oxide core and form a hollow porous carbonized shell material. The step (c) conditions can include contacting the metal oxide core-porous carbonized shell material with a mineral acid, preferably HCl. In step (d) of the method, an elemental sulfur-based material can be incorporated within the hollow space of the carbonized shell to form a yolk-shell structure having a sulfur-based nanostructure positioned within the hollow space of the porous carbonized shell. Incorporating the elemental sulfur-based material of step (d) can include contacting the hollow carbonized shell material with the sulfur-based material under conditions suitable to diffuse the sulfur-based material into the hollow space of the carbonized shell material. In some embodiments, the sulfur-based material is elemental sulfur or lithium sulfide, or both.

In some aspects of the invention, energy storage devices are described. An energy storage device can include a porous material having yolk-shell type structure of the present invention. In some embodiments, the porous material of the present invention is incorporated in an electrode of the energy storage device. In particular, the porous material can be incorporated into a cathode of such a device or an anode of such a device.

In the context of the present invention 20 embodiments are described. Embodiment 1 is a porous material having a yolk-shell type structure, the porous material comprising a sulfur-based material positioned within a hollow space of a porous carbonized metal organic framework (MOF) shell wherein the porous carbonized MOF shell is doped with nitrogen. Embodiment 2 is the porous material of embodiment 1, wherein the porous shell comprises 2 wt. % to 40 wt. % of elemental nitrogen (N), 25 wt. % to 35 wt. % N, or 27 wt. % to 32 wt. % N with the balance being elemental carbon. Embodiment 3 is the porous material of any one of embodiments 1 to 2, wherein the MOF is a zeolitic imidazolate framework (ZIF). Embodiment 4 is the porous material of any one of embodiments 1 to 3, wherein the ZIF is: a ZIF-1 to a ZIF-100, preferably ZIF-8; or a hybrid ZIF, preferably a ZIF7-8, a ZIF8-90, a ZIF7-90. Embodiment 5 is the porous material of any one of embodiments 1 to 4, wherein the carbon shell is substantially defect free. Embodiment 6 is the porous material of any one of embodiments 1 to 5, wherein the hollow space allows for volume expansion of the sulfur-based nanostructure without deforming the porous carbonized shell, preferably a volume expansion of at least 50%. Embodiment 7 is the porous material of any one of embodiments 1 to 6, wherein the sulfur-based material is elemental sulfur or lithium sulfide.

Embodiment 8 is a method of producing a porous material having a yolk-shell structure, the method comprising: (a) combining an organic framework precursor with a suspension comprising zinc oxide (ZnO) under conditions suitable to produce a metal organic framework (MOF) material comprising a ZnO core and an organic framework shell, wherein the organic framework shell encompasses the ZnO core; (b) heat-treating the MOF material under conditions sufficient to carbonize the organic framework shell to produce a core-shell material comprising a ZnO core and a porous carbonized shell; (c) subjecting the ZnO core-porous carbonized shell material of step (b) to conditions sufficient to remove the ZnO and form a hollow porous carbonized shell material; and (d) incorporating a sulfur-based material within the hollow space of the carbonized shell to form a yolk-shell structure having a sulfur-based nanostructure positioned within the hollow space of the porous carbonized shell. Embodiment 9 is the method of embodiment 8, wherein the ZnO suspension comprises zinc oxide (ZnO), alcohol, and water. Embodiment 10 is the method of any one of embodiments 8 to 9, wherein the step (a) conditions comprise agitating the suspension for a time sufficient to allow the organic framework precursor to self-assembly around the ZnO. Embodiment 11 is the method of any one of embodiments 8 to 10, wherein heat-treating comprises heating to a temperature of 550° C. to 1100° C. under an inert atmosphere to carbonize the shell of the MOF and form the porous carbonized shell. Embodiment 12 is the method of any one of embodiments 8 to 11, wherein step (c) conditions comprise contacting the ZnO core-porous carbonized shell material with a mineral acid, preferably HCl. Embodiment 13 is the method of any one of embodiments 8 to 12, wherein incorporating in step (d) comprises contacting the hollow carbonized shell material with the sulfur-based material under conditions suitable to diffuse the sulfur-based material into the hollow space of the carbonized shell material. Embodiment 14 is the method of any one of embodiments 8 to 13, wherein the organic framework precursor is a bidentate carboxylates, a tridentate carboxylates, an amino substituted aromatic dicarboxylic acid, an amino substituted aromatic tricarboxylic acid, an azido substituted aromatic dicarboxylic acid, an azido substituted aromatic tricarboxylic acid, a triazole, a substituted triazole, an imidazole, a substituted imidazole, or mixtures thereof, preferably 2-methylimidazole. Embodiment 15 is the method of any one of embodiments 8 to 14, wherein the porous carbonized shell is defect-free. Embodiment 16 is the method of any one of embodiments 8 to 15, wherein the sulfur-based material is elemental sulfur or lithium sulfide.

Embodiment 17 is an energy storage device comprising the porous material having a yolk-shell type structure of any one of embodiments 1 to 7. Embodiment 18 is the energy storage device of embodiment 17, wherein the energy storage device is a rechargeable battery, preferably a lithium-sulfur battery. Embodiment 19 is the energy storage device of any one of embodiments 17 to 18, wherein the porous material having a yolk-shell type structure is comprised in an electrode of the energy storage device. Embodiment 20 is the energy storage device of embodiment 19, wherein the electrode is a cathode, anode, or both.

The following includes definitions of various terms and phrases used throughout this specification.

The “yolk/shell structure” or “yolk-shell type structure” phrase means that less than 50% of the surface of the “yolk” contacts the shell. The yolk/shell structure has a volume sufficient to allow for volume expansion of the yolk without deforming or expanding the porous material. The yolk can be a nano- or microstructure. By comparison, a “core/shell structure” or “core/shell type structure” means that at least 50% of the surface of the “core” contacts the shell.

Determination of whether a core/shell or yolk/shell is present can be made by persons of ordinary skill in the art. One example is visual inspection of a transition electron microscope (TEM) or a scanning transmission electron microscope (STEM) image of a porous material of the present invention and determining whether at least 50% (core) or less (yolk) of the surface of a given sulfur-based material contacts the porous shell.

“Defect-free” refers to a shell that has a continuous surface. The defect-free shell does not include discontinuous phases or portions of the surface that do not contact one another. An Example of a defect-free shell is shown in FIGS. 3C and 3F. “Nanostructure” refers to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof. “Nanoparticles” include particles having an average diameter size of 1 to 1000 nanometers, with more preferred sizes of 1 to 100 nm.

“Microstructure” refers to an object or material in which at least one dimension of the object or material is greater than 1000 nm (e.g., one dimension is greater than 1000 nm to 10000 nm). In a particular aspect, the microstructure includes at least two dimensions that are greater than 1000 nm (e.g., a first dimension is greater than 1000 nm to 10000 nm in size and a second dimension is greater than 1000 nm to 10000 nm in size). In another aspect, the microstructure includes three dimensions that are greater than 1000 nm (e.g., a first dimension is greater than 1000 nm to 10000 nm in size, a second dimension is greater than 1000 nm to 10000 nm in size, and a third dimension is greater than 1000 nm to 10000 nm in size). The shape of the microstructure can be of a wire, a particle (e.g., having a substantially spherical shape), a rod, a tetrapod, a hyper-branched structure, a tube, a cube, or mixtures thereof. “Microparticles” include particles having an average diameter size of greater than 1000 nm to 10000 nm, with more preferred sizes of 1001 nm to 5000 nm.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting,” “reducing,” “preventing,” “avoiding,” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The porous materials having a yolk-shell structure of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the porous materials of the present invention having yolk-shell structures are their abilities to absorb metal ions such as lithium ions.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIGS. 1A-1B are schematics porous carbon materials having a yolk-shell structure.

FIG. 2 is a schematic of an embodiment of a method of producing the porous carbon materials having a yolk-shell structure.

FIGS. 3A-3H depict the scanning electron microscopy (SEM) and transmission electron microscopy (TEM) images of images of the (FIGS. 3A and 3B) ZnO, (FIGS. 3C and 3D) Zn@ZIF-8 core-shell, (FIGS. 3E and 3F) N-doped carbon hollow shell (CHS) materials of the present invention and (FIGS. 3G and 3H) S@C materials derived from the CHS materials of FIGS. 3E and 3F.

FIGS. 4A-4D depicts a (FIG. 4A) simulated XRD pattern for ZnO (bottom pattern), and an XRD pattern for synthesized ZnO; (FIG. 4B) simulated XRD pattern for ZnO (middle pattern), ZIF-8 XRD simulation (bottom pattern), and XRD pattern for ZnO@ZIF-8 (top pattern); (FIG. 4C) XRD pattern for ZnO@ZIF-8 (bottom pattern), simulated XRD pattern for ZnO (second from bottom pattern), ZnO@C XRD (third from bottom pattern), and HCS XRD pattern (top pattern); and (FIG. 4D) XRD pattern of sulfur (bottom pattern) and XRD pattern of S@C (top pattern).

FIG. 5 shows the thermal gravimetric analysis (TGA) of the S@C yolk-shell composites of the present invention.

While the invention is susceptible to various modifications and alternative forms, specific embodiments thereof are shown by way of example in the drawings. The drawings may not be to scale.

### DETAILED DESCRIPTION OF THE INVENTION

A discovery has been made that provides a solution to the problems associated with storage capacity and charge-discharge cycles for lithium type energy storage devices. The solution is premised on a porous carbon material having a yolk-shell structure that can be defect free. In some embodiments, the porous carbon material can be nitrogen (N)-doped. The incorporation of nitrogen into the carbon shell provides an elegant way to increase absorption of sulfur compounds, thus reducing polysulfide dissolution. Without wishing to be bound by theory, it is believed that when the porous carbon materials of the present invention having a yolk-shell structure are lithiated or charged, the sulfur-based material expands (due to the addition of the lithium ion to the elemental sulfur) inside the hollow portion of the carbonized shell and causes minimal to no deformation or expansion of the shell.

These and other non-limiting aspects of the present invention are discussed in further detail in the following sections.

A. Porous Carbon Material with Yolk-Shell Structure

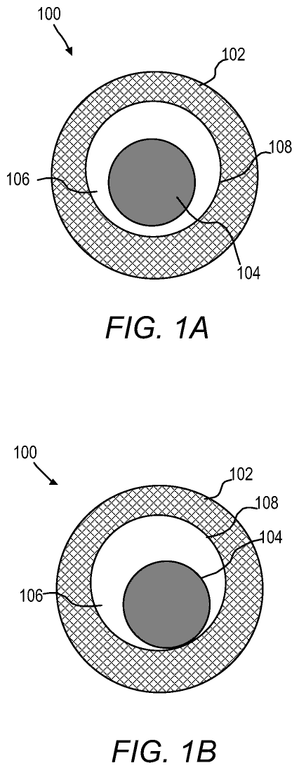

The elemental sulfur yolk/porous carbon-containing shell structure of the present invention includes at least one nanostructure (or in some embodiments a plurality of nanostructures, which can be referred to as a multi-yolk-shell structure) contained within a discrete void space that is present in a carbon shell. FIGS. 1A and 1B are cross-sectional illustrations of porous material 100 having a yolk/porous carbon-containing shell structure. Porous material 100 has porous carbon-containing shell 102, sulfur-based material yolk 104, and hollow void space 106 (hollow space). For multi-yolk-shell structures, at least two yolks 104 (not shown) can be present in hollow void space 106. As discussed in detail below, hollow void space 106 can be formed by removal of a zinc oxide core. Carbon-containing shell 102 can be defect free or substantially defect free as it has a continuous surface or a substantially continuous surface and lacks pin-holes in the shell. In some embodiments, porous carbon-containing shell 102 is N-doped and is defect free. The elemental nitrogen (N) content of the N-doped shell, based on the total weight of the material, can be 2 wt. % to 40 wt. %, 25 wt. % to 35 wt. % N, or 27 wt. % to 32 wt. % or 2 wt. %, 5 wt. %, 10 wt. %, 15 wt. %, 20 wt. %, 25 wt. %, 30, wt. %, 35 wt. % or any range or value there between, with the balance being elemental carbon. The carbonized shell can be derived from carbonization of a metal organic framework material as discussed in detail below. Use of nitrogen-containing organic compounds as the framework precursor material can allow for incorporation of nitrogen throughout the shell. Due to the affinity of nitrogen to bond with sulfur, incorporation of nitrogen can reduce polysulfide dissolution as the sulfur compounds formed during cycling will adsorb or bond to the nitrogen in the shell. The amount of nitrogen in the shell can be tuned by selecting or making the suitable nitrogen-containing organic framework material. In some embodiments, the carbonized MOF shell can be a carbonized zeolitic imidazolate framework (ZIF), a hybrid ZIF, or a functionalized ZIF. Non-limiting examples of ZIFs include ZIF-1 through ZIF-100, preferably ZIF-8. Hybrid ZIF's include framework made from at least two different imidazoles. Functionalized ZIF's include ZIFs having substituents on the imidazole ring (e.g., alkyl, carbonyl, amino substituents, or combinations thereof). Non-limiting examples of such frameworks that can be used in the context of the present invention include ZIF-1, ZIF-2, ZIF-3, ZIF-4, ZIF-5, ZIF-6, ZIF-7, ZIF-8, ZIF-9, ZIF-10, ZIF-11, ZIF-12, ZIF-14, ZIF-60, ZIF-62, ZIF-64, ZIF-65, ZIF-67, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-86, ZIF-90, ZIF-91, ZIF-92, ZIF-93, ZIF-95, ZIF-96, ZIF-97, ZIF-100. Non-limiting examples of hybrid ZIFs include ZIF-7-8, ZIF-8-90. Structures of ZIF-8, ZIF-8-90, and ZIF-8-90-EDA without the zinc oxide are shown below.

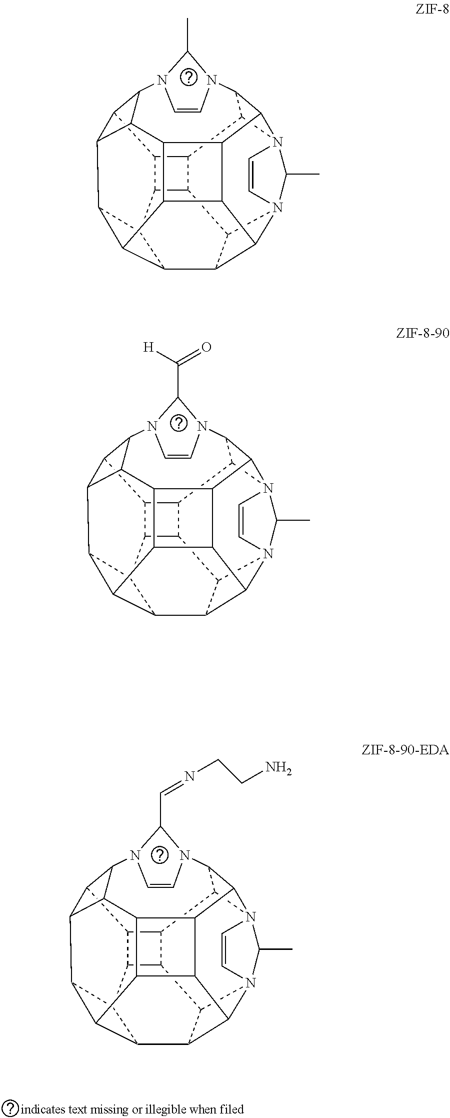

The porous carbon shell and/or N-doped porous carbon shell can allow movement of chemical compounds or ions between an external environment and the interior of the material. Sulfur-based material yolk 104 can be elemental sulfur or lithium sulfide (LiS). Elemental sulfur can include all allotropes of sulfur (i.e., Sₙ where n=1 to cc). Non-limiting examples of sulfur allotropes include S, S₂, S₄, S₆, and S₈, with the most common allotrope being S₈. Yolk 104 can be a micro- or nanostructure. In some instances, yolk 104 is a particle having a diameter from 1 nm to 1000 nm, preferably 1 nm to 50 nm, or more preferably 1 nm to 5 nm or any value or range there between. Wall or interior surface 108 defining hollow void space 106 can be a portion of carbon shell 102. As shown in FIG. 1A, sulfur-based material yolk 104 does not contact shell 102. As shown in FIG. 1B, sulfur-based material yolk 104 contacts a portion of shell 102. In certain aspects, 0% to 49%, 30% to 40%, or 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 36%, 37%, 38%, 39%, 40%, 41%, 42%, 43%, 44%, 45%, 46%, 47%, 48%, 49% or any range or value there between, of the surface of sulfur-based material yolk 104 contacts shell 102. Hollow void space 108 allows for volume expansion of the sulfur-based material without deforming the porous carbonized shell and/or N-doped carbonized shell, preferably a volume expansion of at least 50%, at least 60%, at least 70%, at least 80%, or 50% to 90%, or 60% to 85%, or at least 50%, 55%, 60%, 65%, 70%, 75%, 80%, 85%, 90% or any range or value there between.

B. Method of Producing Porous Carbon Material with Yolk-Shell Structure

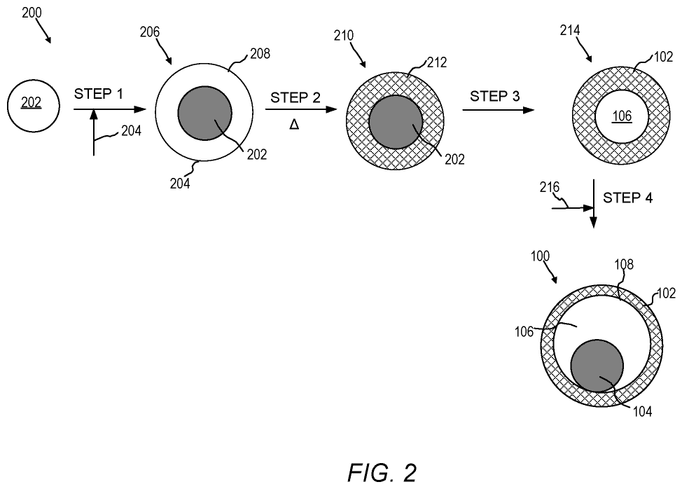

The porous material of the present invention can be made using methods described herein and methods exemplified in the Examples section. FIG. 2 depicts a method to produce a porous material of the present invention having a sulfur-based material as a yolk and a porous carbon containing shell. In method 200, metal oxide (e.g., zinc oxide) particles 202 and organic framework precursor material 204 can be obtained as described below in the Materials Section C of this specification. In step 1 of the method, zinc oxide particles 202 can be dispersed in a solvent (e.g., aqueous alcohol) and organic framework precursor material 204 can be added to the dispersion. In a preferred embodiment, the organic framework precursor material is a nitrogen-containing compound (e.g., 2-methylimidazole), which produces a N-doped shell. The solution can be agitated with optional heating until the organic framework precursor material self-assembles around the zinc oxide to form metal organic framework (MOF) material 206 (e.g., nitrogen doped MOF). In some embodiments, the suspension is agitated for 15 to 60 min, 20 to 50 min or 30 to 40 min at 0 to 100° C., 10 to 90° C., 20 to 80° C., or about room temperature. MOF material 206 has metal oxide core 202 and organic framework shell 208. In some embodiments, the MOF material is isolated and dried. By way of example, the dispersion of MOFs can be separated from the solvent using known techniques such as centrifugation, filtration or the like. After separation, the MOFs can be dried to remove any solvent or water (e.g., 50 to 110° C.).

In step 2, MOF material 206 can be heat-treated under conditions sufficient to carbonize the organic framework shell 208 and produce core-shell material 210 that includes metal oxide (e.g. zinc oxide) core 202 and a porous carbonized shell 212. Core 202 can contact 50% or more, 60% or more, 70% or more, 80% or more, 90% or more, or 99% or more of inner surface 216 of shell 208 or carbonized shell 212. As shown, all or substantially all of outer surface 214 of core 202 contacts inner surface 216 of organic framework shell 208 or carbonized shell 212. Conditions for heat treatment can include heating the MOF at a temperature of 550° C. to 1100° C., 600 to 1000° C., 700 to 900° C., or 550° C., 600° C., 650° C., 700° C., 750° C., 800° C., 850° C., 900° C., 950° C., 1000° C., 1050° C., 1100° C. or any range or value there between under an inert atmosphere to carbonize MOF shell 208 and form the porous carbonized shell 212. The heat treatment can be done under an inert gas atmosphere, such as nitrogen, argon, or helium. The inert gas flow can be from 50 mL/min to 1000 mL/min, 800 mL/min, 600 mL/min, 500 mL/min, 300 mL/min or 100 mL/min or any value or range there between. The pressure during heat treatment can be 0.101 MPa (atmospheric) or higher, for example 10 MPa. In embodiments, when MOF shell 208 includes nitrogen, a porous nitrogen doped carbonized shell 212 is produced.

Step 3 can include metal oxide core-porous carbonized shell material of step 2 to conditions sufficient to remove metal oxide (e.g., ZnO) 202 and form a hollow porous carbonized shell material 214 with porous carbonized shell material 102 encompassing hollow void space 106. The conditions can include treating carbonized material 210 with a reagent capable of removing the metal oxide. In some embodiments, carbonized MOF 210 can be treated with mineral acid (e.g., hydrogen chloride (HCl)) to dissolve metal oxide core 202 and form hollow porous carbonized shell material 214. In some embodiments, the core is ZnO and the mineral acid is HCl.

In step 4 of method 200, sulfur-based material 104 can be obtained as described below in the Materials Section C. Sulfur-based material 104 can be incorporated within hollow space 106 of the carbonized shell 102 to form yolk-shell structure 100 having a sulfur-based material 104 positioned within hollow space 106 of the porous carbonized shell 102. Incorporation can include contacting hollow carbonized shell material 214 with sulfur-based material 104 under conditions suitable to diffuse the sulfur-based material into hollow space 106 of the carbonized shell material. In some embodiments, hollow carbonized shell material 214 and sulfur based material 104 can be placed in a sealed vessel or container and then heated at 130° C. to 160° C., or 135° C. to 155° C., or 140° C. to 150° C., or any range or value there between for a time sufficient (e.g., 5 to 20 hours) to allow the sulfur based material to diffuse into hollow space 106 and/or pores of porous shell 102. An amount of sulfur-based material can vary depending on the application. In some embodiments, a weight ratio of sulfur-based material to hollow carbonized shell material can be 5:1 to 1:5, 4:1 to 2:1, 3:1 to 1:1, 2:1 to 1:4, or about 2:1.

C. Materials

Metal oxide particles 202 can be obtained commercially or made from a metal oxide precursor. Metal oxide precursors can include metal nitrates, metal acetates, metal hydroxides or the like that are converted into oxides upon heating in the presence of a structuring agent. Metals can include transition metals such as Zn, Mg, Ca, Mn, Sr, Fe, Co, Ni, Cu, or alloys thereof, or mixtures thereof. By way of example, a metal acetate material (e.g., Zn(OAc)₂ dihydrate) can be added to diethylene glycol and heated until metal oxides are produced. In some embodiments, the solution can be heated to a temperature of 120° C. to 150° C., 130 to 145° C., or about 140° C. for about 0.5 hours to 1.5 hours, or about 60 min. The time and temperature can be varied to accommodate the size and amount of particles to be obtained.

Organic framework precursor materials can be purchased from commercial supplier or made using known organic synthesis techniques. A non-limiting example of a commercial supplier is SigmaMillipore (U.S.A.). The organic framework precursor can be a bidentate carboxylates, tridentate carboxylates, amino substituted aromatic dicarboxylic acid, an amino substituted aromatic tricarboxylic acid, an azido substituted aromatic dicarboxylic acid, an azido substituted aromatic tricarboxylic acid, a triazole, a substituted triazole, an imidazole, a substituted imidazole, or mixtures thereof. Non-limiting examples of bidentate carboxylic acids include ethanedioic acid, propanedioic acid, butanedioic acid, pentanedioic acid, benzene-1,2-dicarboxylic acid (o-phthalic acid), benzene-1,3-dicarboxylic acid (m-phthalic acid), benzene-1,4-dicarboxylic acid (p-phthalic acid), 2-amino-terephthalic acid, biphenyl-4,4′-dicarboxylic acid (BPDC) and 2,5-dihydroxyterephthalic acid. Non-limiting examples of tridentate carboxylates can include 2-hydroxy-1,2,3-propanetricarboxylic acid (citric acid), benzene-1,3,5-tricarboxylic acid (trimesic acid). Non-limiting examples of imidazole compounds include 2-methylimidazole, 1-ethylimidazole, benzoimidazole and the structures listed below. One or more imidazole compound can be used to make ZIFs, for example, a mixture of two imidazole compounds can be used to make a hybrid ZIF. In a preferred instance, 2-methylimidazole is used to make the ZIF. The following includes some particular organic framework precursor materials that can be used:

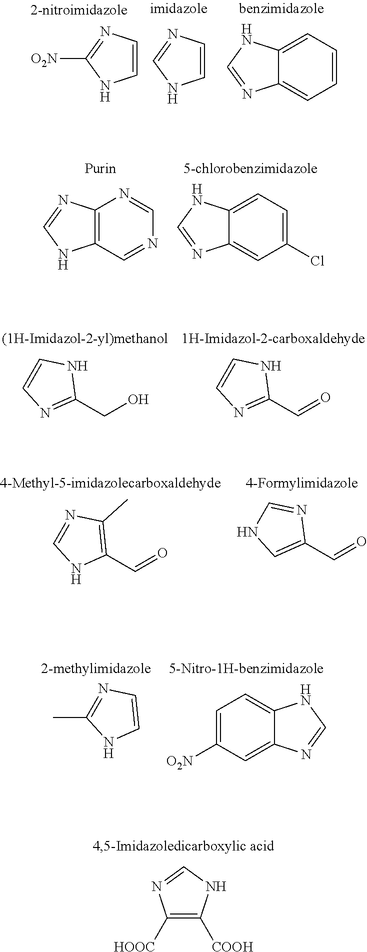

D. Uses of the Porous Carbon-Containing Material with Yolk-Shell Structure

The porous carbon-containing materials of the present invention can be used in a variety of energy storage applications or devices (e.g., fuel cells, batteries, supercapacitors, electrochemical capacitors, lithium-ion battery cells or any other battery cell, system or pack technology), optical applications, and/or controlled release applications. The term “energy storage device” can refer to any device that is capable of at least temporarily storing energy provided to the device and subsequently delivering the energy to a load. Furthermore, an energy storage device may include one or more devices connected in parallel or series in various configurations to obtain a desired storage capacity, output voltage, and/or output current. Such a combination of one or more devices may include one or more forms of stored energy. By way of example a lithium ion battery can include the previously described porous carbon-containing material or multi-yolk/porous carbon-containing material (e.g., on an anode electrode and/or a cathode electrode). In another example, the energy storage device can also, or alternatively, include other technologies for storing energy, such as devices that store energy through performing chemical reactions (e.g., fuel cells), trapping electrical charge, storing electric fields (e.g., capacitors, variable capacitors, ultracapacitors, and the like), and/or storing kinetic energy (e.g., rotational energy in flywheels).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

Chemicals and Instrumentation.

Chemicals were obtained from SigmaMillipore®. All solvents were used as received without further purification. Transmission electron microscope (TEM) pictures were obtained by evaporating a drop of ethanol dispersion of the particles on carbon-coated copper grids followed by the measurement on Tecnai™ Twin TEM (FEI, part of Thermo Fischer Scientific, U.S.A.) operating at 200 kV or 120 KV. The size and morphology of the synthesized composites were characterized by scanning electron microscopy (SEM) analysis using a field emission scanning electron microscope (FESEM, FEI NOVA-NANO SEM-600). Energy dispersive X-ray (EDX) were analyzed in the same way as for SEM in an FEI SEM 600 operated at 10-15 kV. Powder X-ray diffraction (XRD) patterns were PANalytical Empyrean diffractometer (Malvern Panalytical, United Kingdom) using CuKα radiation (λ=1.54059 Å) at 45 kV and 40 mA. Thermogravimetric analysis (TGA) was obtained using a TGA q500 (ta instrument) from 25-800° C. with a heat ramp of 10° C./min under nitrogen or air atmosphere.

### Example 1

### Preparation of Porous Nitrogen Doped Carbon Materials Having a Yolk-Shell Structure

ZnO particles.

Zn(Ac)₂.2H₂O (3.4 g, (20 mmol), Sigma-Aldrich®, U.S.A.) was added into diethylene glycol (DEG, 200 mL) and the solution was heated up to 140° C. and held for 60 minutes to produce ZnO particles. The ZnO particles were centrifuged, washed with alcohol, and dried at 80° C. in vacuum.

ZnO@ZIF-8.

The ZnO (1 g) was added into ethanol-water mixed solution (120 mL, ethanol:water=3:1, v/v). Subsequently, 2-methylimidazolate (2 g, Sigma-Aldrich®, U.S.A.) was added with agitation. The solution was stirred for an additional 30 min. The ZnO@ZIF-8 core-shell material was isolated by centrifugation, and then washed with ethanol.

Preparation of nitrogen doped hollow carbon spheres.

ZnO@ZIF-8 particles (1 g) were loaded into a tube furnace and heated under a N2 atmosphere with a heating rate of 5° C. per min. from room temperature to 600° C., followed by natural cooling to room temperature. The obtained black powder was mixed with HCl (10 ml, 0.1 M) and stirred for 2 hours. After centrifugation and washing with H₂O and ethanol, a black powder of nitrogen doped hollow carbon spheres (HCS) was obtained.

Synthesis of S@C yolk-shell composites.

Elemental sulfur (1 g, SigmaMillipore U.S.A.) was mixed with the prepared HCS (0.5 g) and sealed in an autoclave and heated at 150° C. for 12 hours to allow for sufficient diffusion of melted sulfur into the hollow space of the carbon spheres and produce the porous nitrogen doped carbon materials of the present invention having a yolk/shell structure.

### Example 2

### Characterization of Nitrogen Doped Carbon Materials Having a Yolk-Shell Structure

The materials of Example 1 were analyzed by scanning electron microscopy (SEM), transmission electron microscopy (TEM), X-ray diffraction (XRD) and energy dispersive X-ray (EDX) spectroscopy and TGA.

SEM and TEM analysis.

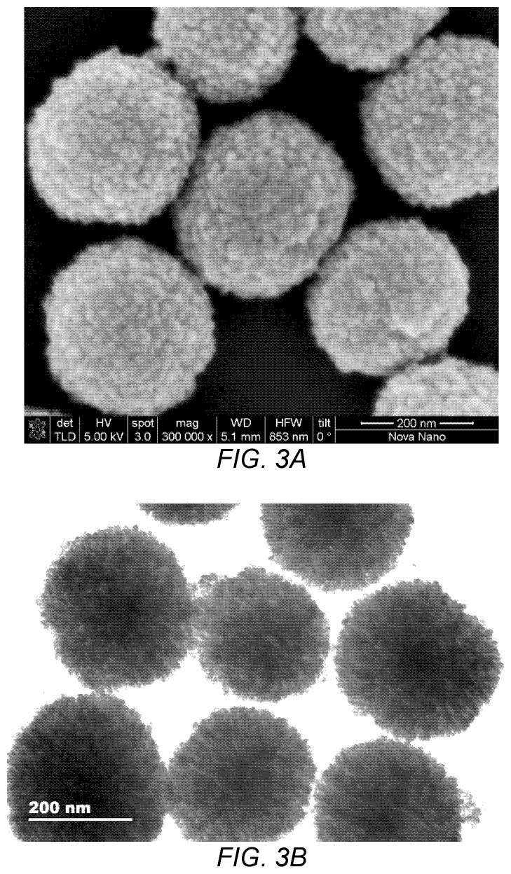

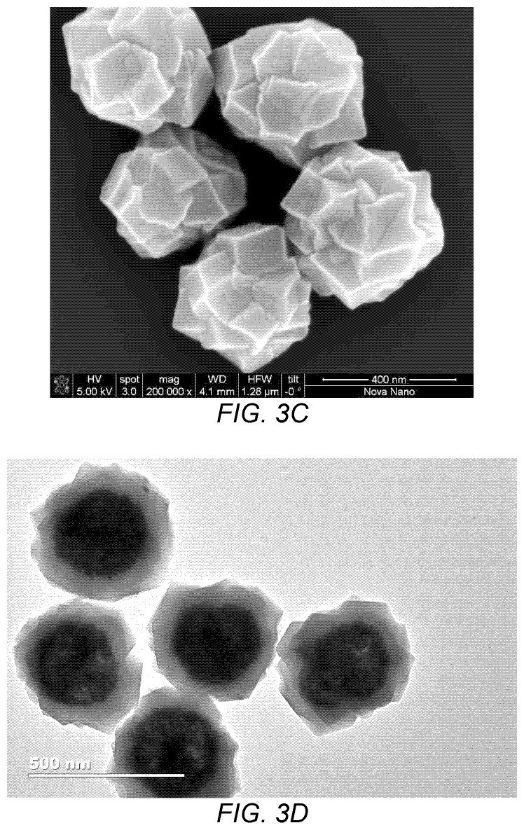

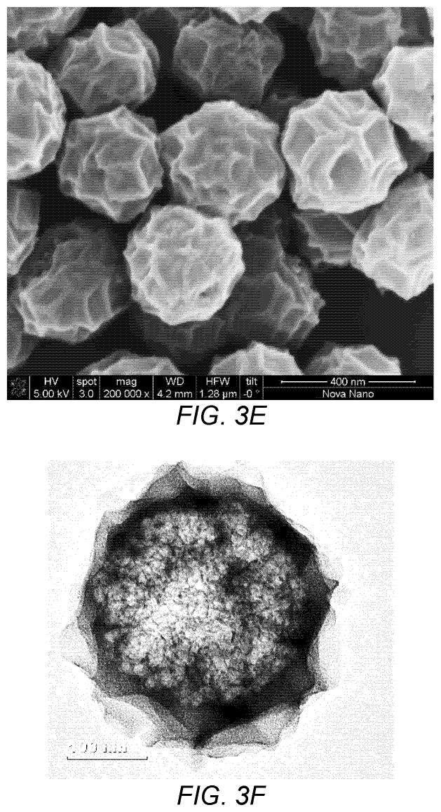

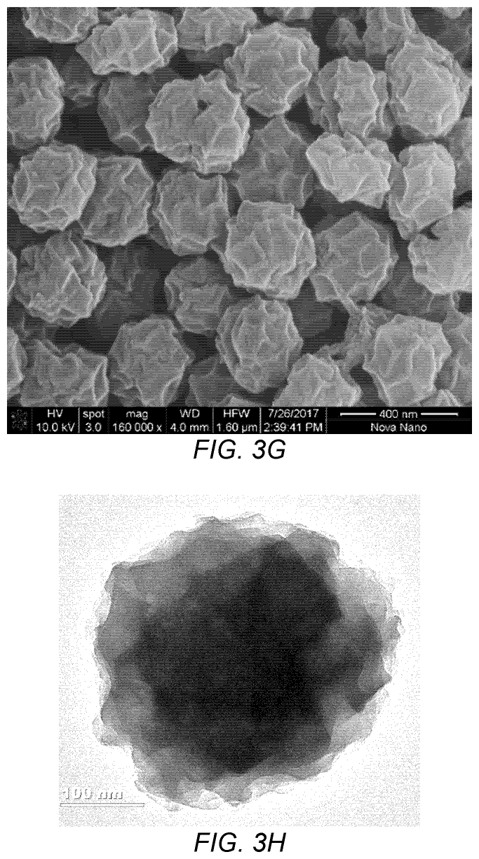

The ZnO, Zn@ZIF-8 core-shell, N-doped carbon hollow shell were analyzed by SEM and TEM. FIGS. 3A-H depict the SEM and TEM images of the ZnO, Zn@ZIF-8 core-shell, calcined Zn@ZIF-8 core-shell, and N-doped carbon hollow shell materials. FIG. 3A is a SEM image of ZnO particles as synthesized. FIG. 3B is a TEM image of ZnO particles as synthesized. FIG. 3C is SEM image of Zn@ZIF-8 core-shell. FIG. 3D is TEM image of Zn@ZIF-8 core-shell. FIG. 3E is a SEM image of N-doped carbon hollow shell material. FIG. 3F is a TEM image of N-doped carbon hollow shell material. FIG. 3G is a SEM image of S@C yolk-shell material. FIG. 3H is a TEM image of S@C yolk-shell material. From analysis of the SEM and TEM of the N-doped carbon hollow shell (FIGS. 3B and 3F), it was determined that the shell was defect free.

X-ray diffraction analysis.

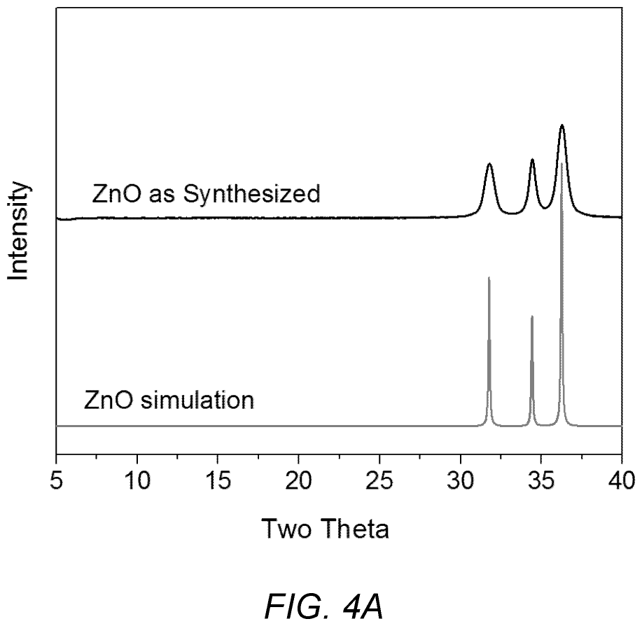

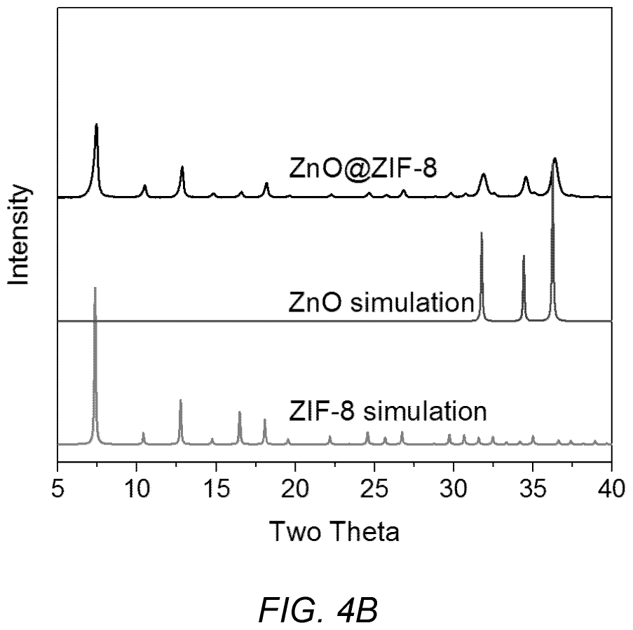

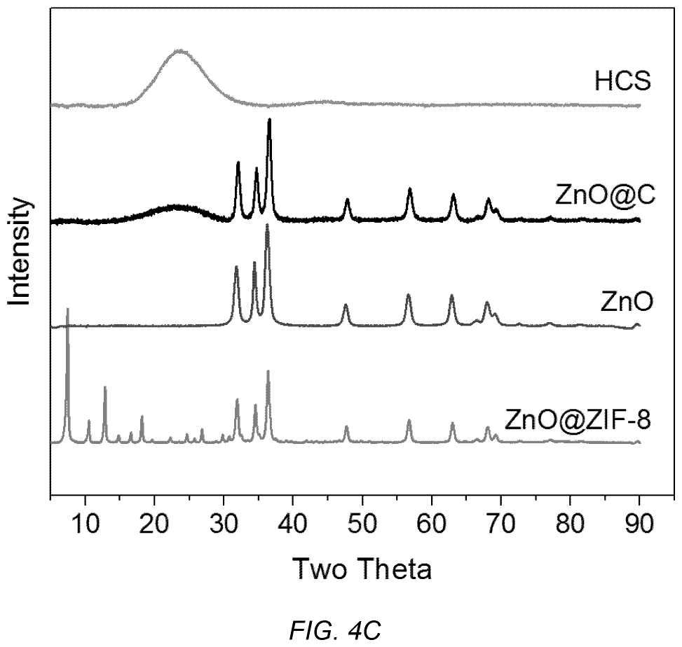

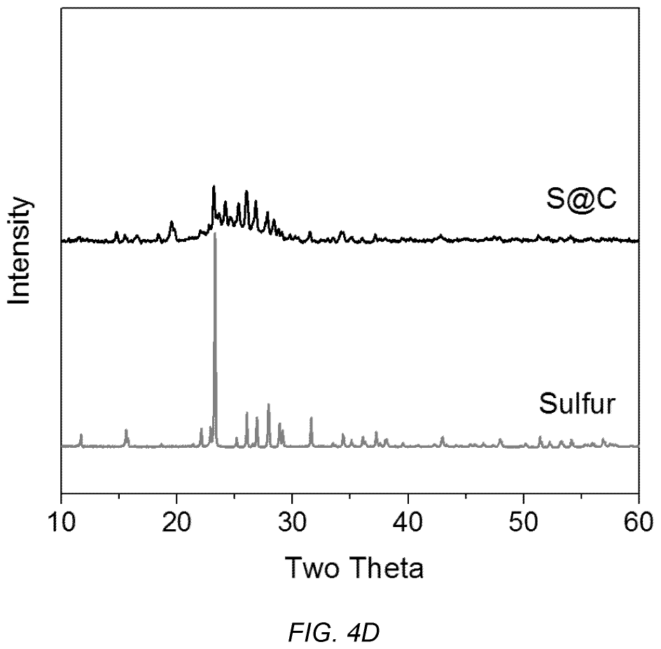

The ZnO, Zn@ZIF-8 core-shell, N-doped carbon hollow shell were analyzed by XRD. FIG. 4A depicts a simulated XRD pattern for ZnO (bottom pattern), and an XRD pattern for synthesized ZnO. The two XRD patterns matched very well, which means the synthesized particles were ZnO. FIG. 4B depicts a simulated XRD pattern for ZnO (middle pattern), ZIF-8 XRD simulation (bottom pattern), and XRD pattern for ZnO@ZIF-8 (top pattern). The ZnO@ZIF-8 particles had the same peaks from ZnO and ZIF-8. Thus, the synthesized particles were ZnO@ZIF-8 core-shell structure. FIG. 4C depicts an XRD pattern for ZnO@ZIF-8 (bottom pattern), simulated XRD pattern for ZnO (second from bottom pattern), ZnO@C XRD (third from bottom pattern), and HCS XRD pattern (top pattern). The XRD ZnO@C shows that the ZIF-8 peaks disappeared after calcination. After treatment with HCl, the peak of ZnO disappeared, which means most of ZnO was removed. FIG. 4D shows XRD pattern of sulfur (bottom pattern) and XRD pattern of S@C (top pattern). The XRD patterns shows sulfur peaks appeared in the S@C yolk-shell composite.

EDX analysis.

The ZnO, ZnO@ZIF-8, N-doped carbon hollow shell, and S@C were analyzed by EDX. Table 1 lists the values for ZnO, Table 2 lists the values for ZnO@ZIF-8, Table 3 lists the values for carbon, nitrogen, oxygen, and zinc for the n-doped HCS, and Table 4 lists the values for carbon and sulfur the S@C. From EDX it was determined 1) the ZnO particles include only Zn and oxygen atoms, 2) the ZnO@ZIF-8 included only Zn atoms, oxygen atoms, nitrogen atoms and carbon atoms; 3) the N-doped carbon hollow shell had some zinc oxide remaining in the hollow void, and 4) S@C has some residual nitrogen atoms. Inclusion of some zinc oxide in the HSC particles can be used to absorb polysulfides during discharge.

TABLE 1
ZnO

| Element | Wt. % | Atomic % |
|---|---|---|
| CK | 2028 | 7.59 |
| OK | 17.27 | 43.18 |
| ZnL | 80.45 | 49.23 |

Matrix correction ZAF

TABLE 2
ZNO@ZIF-8

| Element | Wt. % | Atomic % |
|---|---|---|
| CK | 22.29 | 46.45 |
| NK | 10.62 | 18.97 |
| OK | 07.54 | 11.79 |
| ZnL | 59.55 | 22.8 |

Matrix correction ZAF

TABLE 3
HCS

| Element | Wt. % | Atomic % |
|---|---|---|
| CK | 58.24 | 69.18 |
| NK | 20.75 | 21.13 |
| OK | 07.57 | 6.75 |
| ZnL | 13.45 | 2.94 |

Matrix correction ZAF

TABLE 4
S@C

| Element | Wt. % | Atomic % |
|---|---|---|
| CK | 39.06 | 55.46 |
| NK | 13.63 | 16.60 |
| OK | 05.19 | 05.53 |
| SK | 42.12 | 22.41 |

Matrix correction ZAF

TGA analysis.

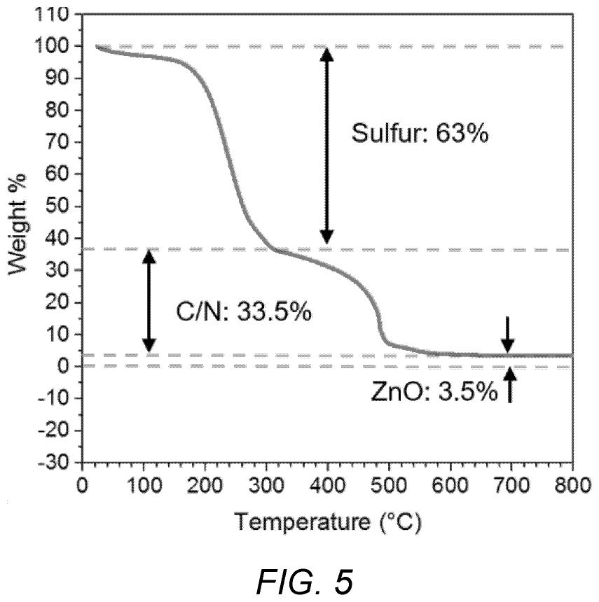

The sulfur loading of S@C yolk-shell composite was tested by TGA (FIG. 5) under air. It shows the sulfur loading is around 63 wt. %. The weight of carbon and nitrogen is around 33.5% and the undecomposed ZnO is around 3.5 wt. %.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A porous material having a yolk-shell type structure, the porous material comprising a sulfur-based material positioned within a hollow space of a porous carbonized metal organic framework (MOF) shell wherein the porous carbonized MOF shell is doped with nitrogen.

2. The porous material of claim 1, wherein the porous shell comprises 2 wt. % to 40 wt. % of elemental nitrogen (N), 25 wt. % to 35 wt. % N, or 27 wt. % to 32 wt. % N with the balance being elemental carbon.

3. The porous material of claim 1, wherein the MOF is a zeolitic imidazolate framework (ZIF).

4. The porous material of claim 3, wherein the ZIF is:
a ZIF-1 to a ZIF-100; or
a hybrid ZIF.

5. The porous material of claim 1, wherein the carbon shell is substantially defect free.

6. The porous material of claim 1, wherein the hollow space allows for volume expansion of the sulfur-based nanostructure without deforming the porous carbonized shell.

7. The porous material of claim 1, wherein the sulfur-based material is elemental sulfur or lithium sulfide.

8. A method of producing a porous material having a yolk-shell structure, the method comprising:
(a) combining an organic framework precursor with a suspension comprising zinc oxide (ZnO) under conditions suitable to produce a metal organic framework (MOF) material comprising a ZnO core and an organic framework shell, wherein the organic framework shell encompasses the ZnO core;
(b) heat-treating the MOF material under conditions sufficient to carbonize the organic framework shell to produce a core-shell material comprising a ZnO core and a porous carbonized shell;
(c) subjecting the ZnO core-porous carbonized shell material of step (b) to conditions sufficient to remove the ZnO and form a hollow porous carbonized shell material; and
(d) incorporating a sulfur-based material within the hollow space of the carbonized shell to form a yolk-shell structure having a sulfur-based nanostructure positioned within the hollow space of the porous carbonized shell.

9. The method of claim 8, wherein the ZnO suspension comprises zinc oxide (ZnO), alcohol, and water.

10. The method of claim 8, wherein the step (a) conditions comprise agitating the suspension for a time sufficient to allow the organic framework precursor to self-assembly around the ZnO.

11. The method of claim 8, wherein heat-treating comprises heating to a temperature of 550° C. to 1100° C. under an inert atmosphere to carbonize the shell of the MOF and form the porous carbonized shell.

12. The method of claim 8, wherein step (c) conditions comprise contacting the ZnO core-porous carbonized shell material with a mineral acid.

13. The method of claim 8, wherein incorporating in step (d) comprises contacting the hollow carbonized shell material with the sulfur-based material under conditions suitable to diffuse the sulfur-based material into the hollow space of the carbonized shell material.

14. The method of claim 8, wherein the organic framework precursor is a bidentate carboxylates, a tridentate carboxylates, an amino substituted aromatic dicarboxylic acid, an amino substituted aromatic tricarboxylic acid, an azido substituted aromatic dicarboxylic acid, an azido substituted aromatic tricarboxylic acid, a triazole, a substituted triazole, an imidazole, a substituted imidazole, or mixtures thereof.

15. The method of claim 8, wherein the porous carbonized shell is defect-free.

16. The method of claim 8, wherein the sulfur-based material is elemental sulfur or lithium sulfide.

17. An energy storage device comprising the porous material having a yolk-shell type structure of claim 1.

18. The energy storage device of claim 17, wherein the energy storage device is a rechargeable battery.

19. The energy storage device of claim 17, wherein the porous material having a yolk-shell type structure is comprised in an electrode of the energy storage device.

20. The energy storage device of claim 19, wherein the electrode is a cathode, anode, or both.
